(19) United States
(12) Patent Application Publication
(10) Pub. No.: US 2006/0145014 A1
(43) Pub. Date: Jul. 6, 2006

(54) Magnetic closing method for parachutes

(75) Inventor: Daniel J. Preston, Kew Gardens, NY (US)

Correspondence Address: BOURQUE & ASSOCIATES, P.A., 835 HANOVER STREET, SUITE 301, MANCHESTER, NH, 03104, US

(73) Assignee: Atair Aerospace, Brooklyn, NY (US)

(21) Appl. No.: 11/270,048

(22) Filed: Nov. 9, 2005

Related U.S. Application Data
(60) Provisional application No. 60/626,175, filed on Nov. 9, 2004.

(51) Int. Cl. B64D 17/40

(52) U.S. Cl. 244/148

(57) ABSTRACT

A fastening system particularly suited for removably securing a first component of a parachute system to a second component. The fastening system includes a first and at least a second magnetic element secured to the first and second components of the parachute system. At least the first magnetic element is adapted to create a magnetic field that attracts the second magnetic element. In the preferred embodiment, both the first and second create magnetic fields which attract each other and may include permanent magnets or temporary magnets. Alternatively, the magnetic elements may include electromagnets connected to a power source. Optionally, a power controller adjusts the strength of the magnetic force generated by the magnetic elements.

### CROSS-REFERENCE TO RELATED APPLICATIONS

This application claims the benefit of U.S. Provisional Application Ser. No. 60/626,175, filed Nov. 9, 2004, which is hereby fully incorporated by reference.

### TECHNICAL FIELD

The present invention relates to fastening systems and more particularly, relates to fastening systems for use with parachute rigs and equipment.

### BACKGROUND INFORMATION

Parachute harness/container systems require certain areas such as, but not limited to, the main parachute deployment pin, the reserve parachute deployment pin, and riser covers, to be covered and protected. These key areas are covered so as to protect against premature deployment or other malfunctions caused by bumping or snagging before or during use, or blowing something open during use at high air speeds.

The most common method of protection is to construct fabric covers that are held together using a hook and loop type fastener such as Velcro®. When deployment is initiated, the pilot chute creates a force that causes the hook and loop fastener to separate and the cover to open, thus allowing the parachute to deploy. Unfortunately, this method suffers from several disadvantages.

One disadvantage of the hook and loop type fastener/cover is that it is maintenance intensive. The hook and loop type fastener wears quickly. As it wears, the ability of the hook and loop type fastener to remain secured becomes compromised. As a result, it must be constantly monitored and replaced often.

Another disadvantage of the hook and loop type fastener is that the hook side of the hook and loop fastener is abrasive. This is particularly problematic since it causes premature failure for a variety of parachute parts including, but not limited to, parachute lines, webbing and fabric.

To overcome these problems “tuck flaps” were developed. In tuck flap construction, the fabric covers are stiffened by sewing in plastic and instead of relying on a hook and loop fastener. The stiff plastic cover is fashioned with a tab that can tuck into a mating pocket. This system eliminates the problems associated with hook and loop fasteners, but posses many shortcomings of its own.

One disadvantage of tuck flaps is that the tuck flaps are not always secure and often blow open at high speeds. A premature deployment can result from insecure flaps and at high speeds can lead to serious injury or death. Another disadvantage is that tuck flaps are difficult and time consuming to construct. Additionally, the stiff plastic becomes more flexible with repeated use and tuck flap becomes less secure.

Therefore there exists a need for an improved method of protection for closing flaps on parachute rigs. The method should preferably be easy to construct and not require extensive maintenance/monitoring. The method should also preferably minimize the likelihood of accidental damage to other parts of the parachute rig and should preferably be capable of repetitive use.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following claims.

### SUMMARY

According to one embodiment, the present invention features a parachute system a first component and at least a second component adapted to be removably secured to each other. A first magnetic element is secured to the first component and is adapted to create a first magnetic field. At least a second magnetic element is secured to the second component and includes a material that is attracted to the first magnetic element. The magnetic elements may be secured using an adhesive, within a cavity disposed in either the first or the at least a second component, or sewn to either the first or the at least a second component. Optionally, either the first or the second components includes a stiffening element, wherein the stiffening element includes either the first or the second magnetic elements.

In the preferred embodiment, the second magnetic element is adapted to create a second magnetic field that is attracted to the first magnetic field. The first and second components may include a fabric cover and a container for storage of a parachute, a parachute toggle and a parachute riser, a parachute toggle and a parachute riser, a pilot chute bridal hesitation mechanism, or a parachute instrument display and a parachute harness.

The first and/or the second magnetic elements may include a permanent magnet or a temporary magnet. Alternatively, the first and/or the second magnetic elements may include an electromagnet and a power source for providing power to the electromagnet. Optionally, the parachute system may include a power controller for adjusting the strength of a magnetic force created by the first and the second magnetic elements. The power controller optionally includes a first setting wherein the magnetic force is substantially at a maximum value and at least a second setting wherein the magnetic force is lower than a minimum threshold value necessary to maintain a connection between the first and the second component during operation of the parachute system.

According to another embodiment, the present invention features a method of removably fastening a first component and at least a second component of a parachute system. The method includes the acts of providing the first component with a first magnetic element, providing the second component with at least a second magnetic element, and creating a magnetic force between the first and the second component. The first and the second magnetic elements may include either a permanent magnet or an electromagnet. In the case where an electromagnet is used, the method optionally includes the act of adjusting a magnetic force generated by the first and the second magnetic elements by adjusting the power to the electromagnet.

### BRIEF DESCRIPTION OF THE DRAWINGS

These and other features and advantages of the present invention will be better understood by reading the following detailed description, taken together with the drawings wherein:

FIG. 1a is a plan view of one embodiment of the fastening system shown in an open or unsecured position according to the present invention;

FIG. 1b is a plan view of one embodiment of the fastening system shown in a closed or secured position according to the present invention;

FIG. 2 is a plan view of another embodiment of the fastening system according to the present invention;

FIG. 3 is an illustrative view of one embodiment of the orientation of the magnetic elements of the fastening system according to the present invention; and

FIG. 4 is a plan view of a further embodiment of the fastening system according to the present invention having a stiffening structure.

### DETAILED DESCRIPTION OF THE PREFERRED EMBODIMENTS

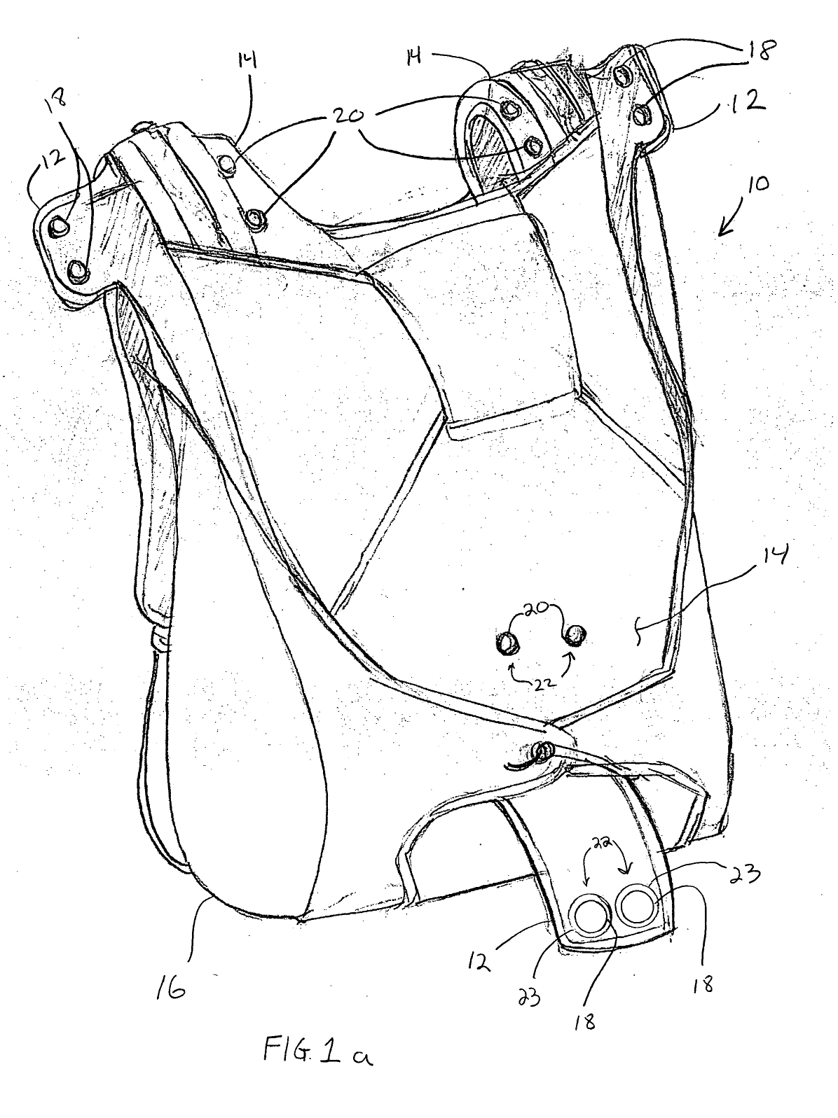

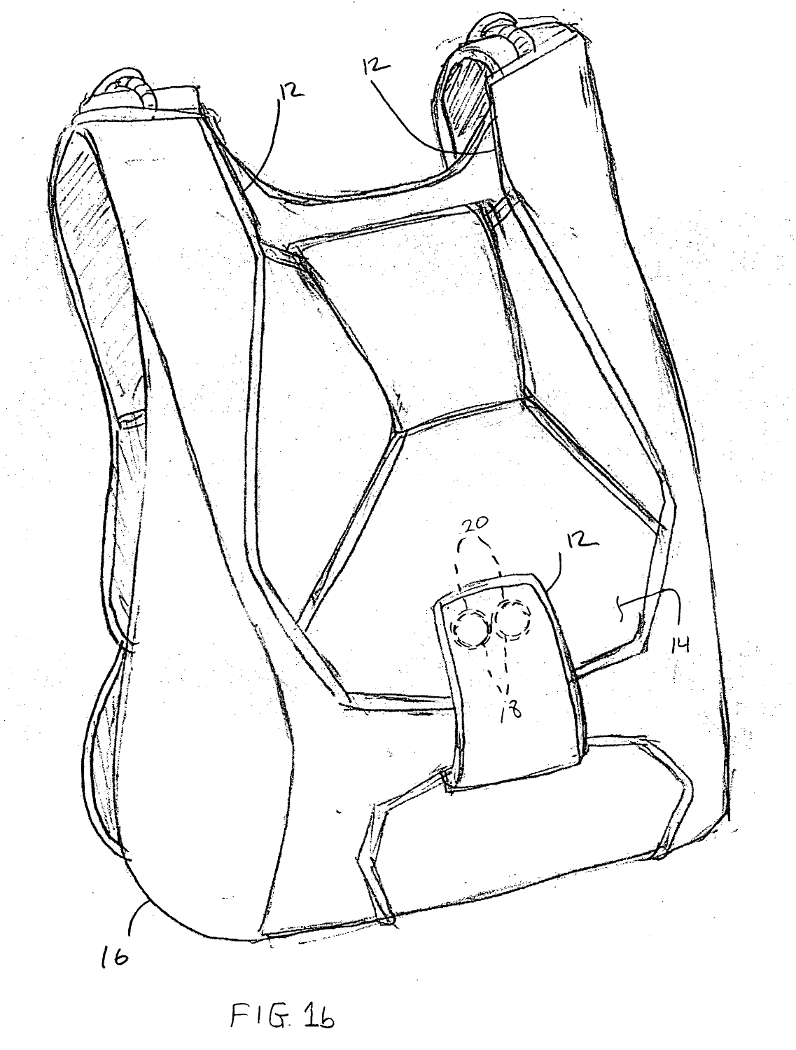

According to one embodiment, the present invention features an apparatus and method 10, FIG. 1, for securing together two or more parts 12, 14 of a parachute, parachute gear, or the like 16, without the use or need of hook and loop fasteners and/or tuck flaps. The present invention features a fastening system 10 comprising at least one magnetic element 18 disposed on at least a part of a first object 12 that is magnetically attracted to part of at least a second object 14. The fastening system 10 is capable of withstanding the forces generated during repetitive use without undue repair or maintenance.

For illustrative purposes only, the present invention will be described with respect to protective flaps for use of parachutes or the like, though one skilled in the art will readily recognize that the present invention has numerous uses on parachute rigs such as, but not limited to, securing toggles to the risers, replacing hook and loop fasteners used in pilot chute bridal hesitation, securing instrumentation, and the like.

In the preferred embodiment, the fastening system 10 includes a first magnetic element 18 and a second magnetic element 20. The magnetic elements 18, 20 may include any device capable of generating a magnetic field such as, but not limited to, permanent magnets, temporary magnets, as well as electromagnets or any device which is attracted by a magnetic force. In the exemplary embodiment, the magnetic elements 18, 20 include high strength magnets such as rare earth magnets, for example but not limited to, neodymium-iron-boron (NdFeB), Samarium Cobalt (SmCo), Alnico, Ceramic, Ferrite, or the like. Alternatively, an electrical current may be applied to the magnetic elements 18, 20 to cause a magnetic field.

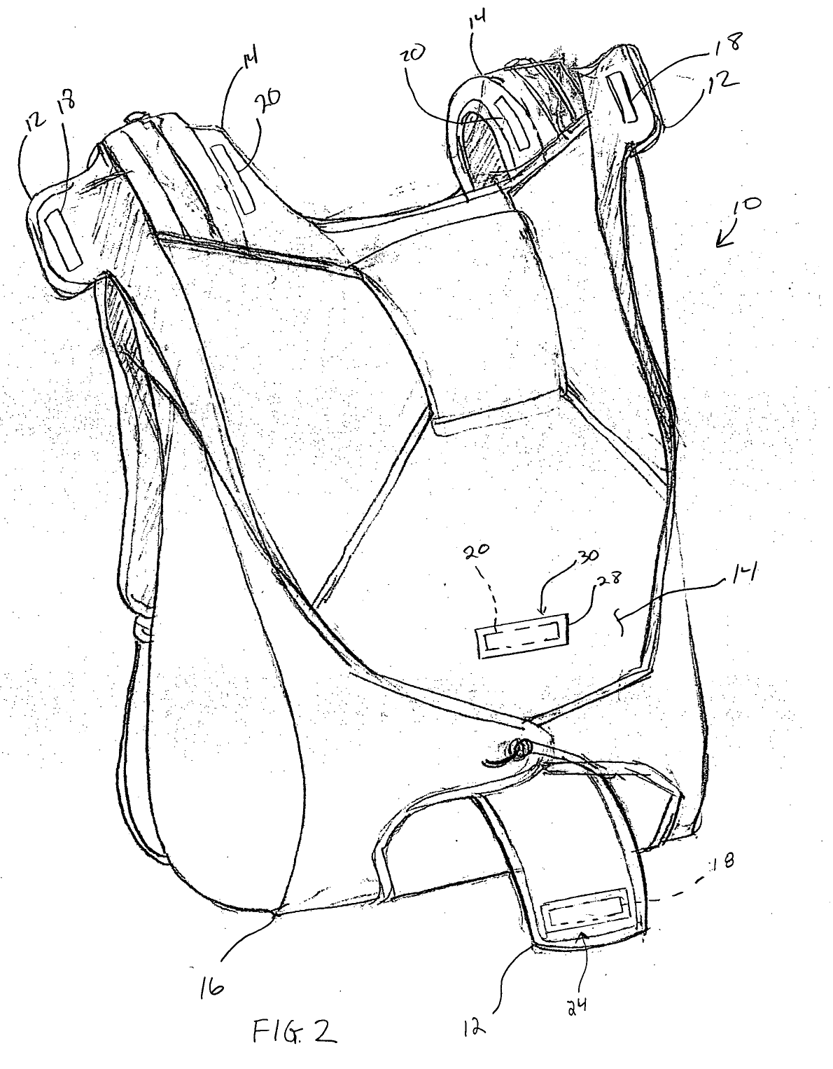

In prototyping, several small NdFeB magnets have been tested, sizes ranging from generally circular magnets 22 having a dimensions of approximately 3/16″ in diameter by approximately 1/16″ thick as shown FIG. 1, to thin bars 24 having dimensions of approximately ¼″ by approximately 1″ by approximately 3/16″ to larger disks of approximately 1″ by approximately ⅛″ as shown in FIG. 2.

According to one embodiment, the magnets 18, 20 may be disposed on the objects 12, 14 using an adhesive. To further secure the magnets, a pouch, pocket, or cavity 23 may be formed on/in the object that is sized and shaped to accept the magnet 18, 20. Alternatively, the magnets 18, 20 may be secured to the objects 12, 14 using a fastener system such as a button as described in U.S. Pat. No. 6,170,131 which is fully incorporated herein by reference.

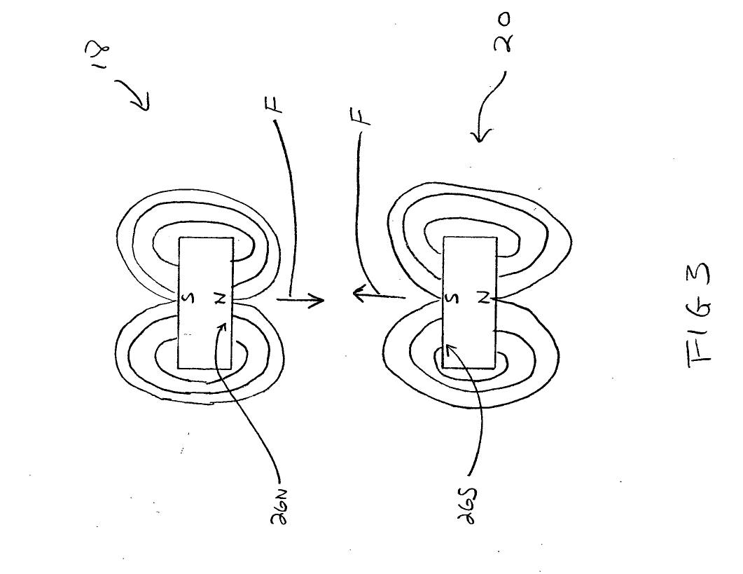

When two magnets 18, 20, FIG. 3, are utilized, the poles 26 of each of the magnets 18, 20 are positioned to create an attractive magnetic force F between the two magnetic elements 18, 20. The desired holding force F can be controlled by altering the choice of magnet type, the thickness of fabric or material separating the two magnetic elements 18, 20 (if any), as well as the size and shape of the magnetic elements 18, 20. Additionally, when an electromagnetic magnet is utilized, the holding force F can be altered by adjusting the electric current applied. In preliminary testing, holing forces F from less than approximately 1 pound to more than approximately 30 pounds were easily possible with small magnets 18, 20.

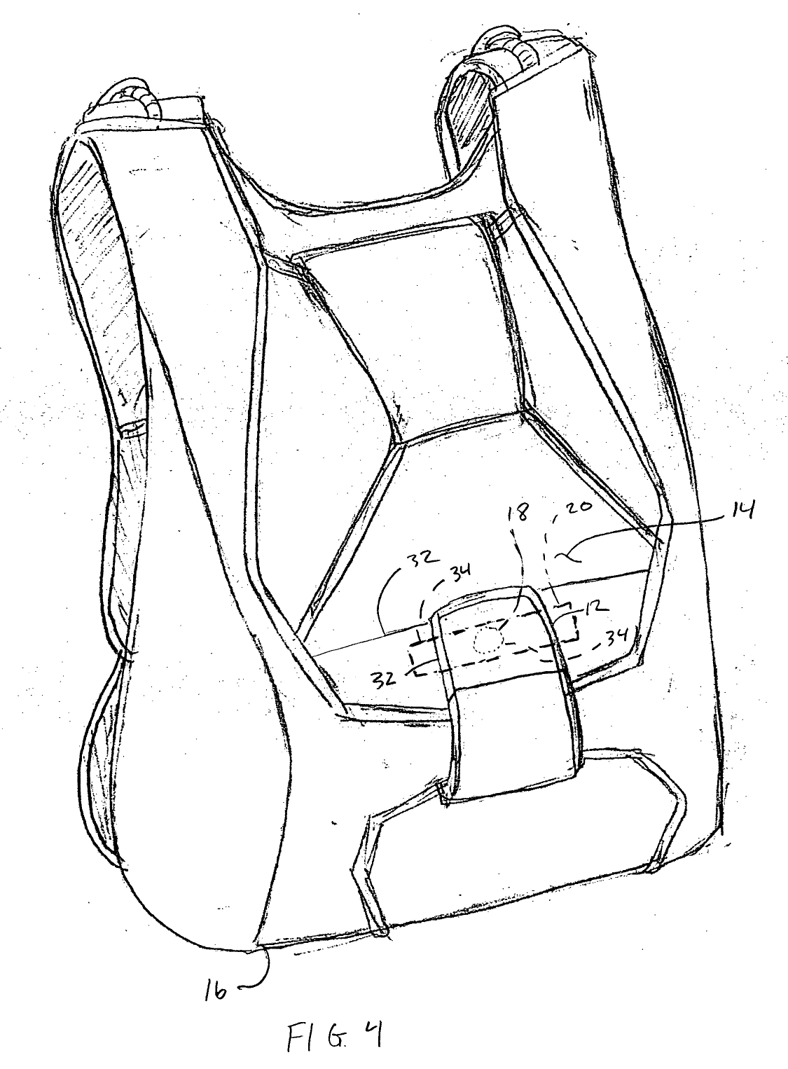

Magnets 18, 20 can be automatically sewn trapped in place by use of a bar tack machine that is programmed to stitch a pattern 28 around the circumference of the magnet 18, 20 to form a pocket, cavity, or pouch 30 in one step. Such construction takes only seconds and makes for economical high volume production. Alternatively, the magnetic elements 18, 20 may form “snaps”, “buttons”, or “metal holders” that can be crimped, molded, adhered, or otherwise secured using any device/method known to those skilled in the art.

Where stiffened construction is required, magnets 18, 20, FIG. 4, can be incorporated into plastic sheet 32 or ballistic by placing into a cutout 34 in the material 32 and laminating to fabric. Additionally, the stiffening material itself may be made from a material having or capable of having magnetic properties.

In an alternative embodiment, the fastening system 10 may include a first magnetic element 18 capable of generating a magnetic field and a second magnetic element 20 which is not normally magnetic, but which is attracted to the magnetic field generated by the first magnetic element 18. According to this embodiment, the first magnetic element 18 may include any magnet disclosed above and the second magnetic element 20 may include any material which is attracted by the magnetic filed such as, but limited to, metals, minerals, ferrofluids, or the like.

The inventive magnetic method of closing protective flaps on parachutes rigs overcomes all of the problems of hook and loop type fasteners and tuck flap construction, yielding a clean, secure, non-wearing, mechanism that is uncomplicated and economical to manufacture.

As mentioned above, the present invention is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the claims when interpreted in accordance with breadth to which they are fairly, legally and equitably entitled.

The invention claimed is:

1. A parachute system comprising:
a first component and at least a second component adapted to be removably secured to each other;
a first magnetic element secured to said first component, said first magnetic element adapted to create a first magnetic field; and
at least a second magnetic element secured to said at least a second component, said at least a second magnetic element including a material that is attracted to said first magnetic element.

2. The parachute system as claimed in claim 1 wherein said first and said at least a second components include a fabric cover and a container for storage of a parachute.

3. The parachute system as claimed in claim 1 wherein said first and said at least a second components include a parachute toggle and a parachute riser.

4. The parachute system as claimed in claim 1 wherein said first and said at least a second components include a pilot chute bridal hesitation mechanism.

5. The parachute system as claimed in claim 1 wherein said first and said at least a second components include a parachute instrument display and a parachute harness.

6. The parachute system as claimed in claim 1 wherein said at least a second magnetic element is adapted to create a second magnetic field, wherein said first and said second magnetic fields attract each other.

7. The parachute system as claimed in claim 1 wherein at least one of said first and said at least a second magnetic elements includes a permanent magnet.

8. The parachute system as claimed in claim 1 wherein at least one of said first and said at least a second magnetic elements includes an electromagnet.

9. The parachute system as claimed in claim 8 further including a power source for providing power to said electromagnet.

10. The parachute system as claimed in claim 9 further including a power controller, for adjusting the strength of a magnetic force created by said first and said at least a second magnetic elements.

11. The parachute system as claimed in claim 10 wherein said power controller includes a first setting wherein said magnetic force is substantially at a maximum value and at least a second setting wherein said magnetic force is lower than a minimum threshold value necessary to maintain a connection between said first and said at least a second component during operation of said parachute system.

12. The parachute system as claimed in claim 1 wherein at least one of said first and said at least a second magnetic elements is secured using an adhesive.

13. The parachute system as claimed in claim 1 wherein at least one of said first and said at least a second magnetic elements is secured within a cavity disposed in either said first or said at least a second component.

14. The parachute system as claimed in claim 1 wherein at least one of said first and said at least a second magnetic elements is sewn to either said first or said at least a second component.

15. The parachute system as claimed in claim 1 wherein at least one of said first and said at least a second components includes a stiffening element, wherein said stiffening element includes either said first or said at least a second magnetic elements.

16. A method of removably fastening a first component and at least a second component of a parachute system comprising:
providing said first component with a first magnetic element;
providing said at least a second component with at least a second magnetic element; and
creating a magnetic force between said first and said at least a second component.

17. The method as claimed in claim 16 wherein at least said first magnetic element is a permanent magnet.

18. The method as claimed in claim 16 wherein at least said first magnetic element is an electromagnet.

19. The method as claimed in claim 18 further including the act of adjusting a magnetic force generated by said first and said at least a second magnetic elements.

20. The method as claimed in claim 16 wherein said first and said at least a second components include a fabric cover and a container for storage of a parachute.
